(19) United States
(12) Patent Application Publication
(10) Pub. No.: US 2004/0205036 A1
(43) Pub. Date: Oct. 14, 2004

(54) Optimization on lie manifolds

(76) Inventors: Nagabhushana Prabhu, West Lafayette, IN (US); Hung-Chich Chang, Weatherford, OK (US)

Correspondence Address: Charles C Valauskas, Baniak Pine & Gannon, Suite 1200, 150 North Wacker Drive, Chicago, IL, 60606-1606, US

(21) Appl. No.: 10/476,432

(22) PCT Filed: Apr. 30, 2002
(86) PCT No.: PCT/US02/13314

Related U.S. Application Data
(60) Provisional application No. 60/287,624, filed on Apr. 30, 2001.

(51) Int. Cl. G06E 1/00; G06E 3/00; G06G 7/00; G06F 15/18; G06F 19/00

(52) U.S. Cl. 706/19; 706/20

(57) ABSTRACT

The present invention is a system and method of improving computational efficiency of constrained nonlinear problems by utilizing Lie groups and their associated Lie algebras to transform constrained nonlinear problems into equivalent unconstrained problems. A first nonlinear surface including a plurality of points is used to determine a second nonlinear surface that also includes a plurality of points. A reference point is selected from the plurality of points of the second nonlinear surface. An objective function equation is maximized by computing a gradient direction line from the reference point. The reference point is adjusted to the point determined along the gradient direction line having the highest associated value.

### 1 FIELD OF THE INVENTION

### 2 BACKGROUND OF THE INVENTION

### 3 SUMMARY OF THE INVENTION

A large class of pattern recognition problems can be formulated in a natural way as optimization over transformation groups. In general, such optimization problems are nonlinear, severely constrained and hence very intractable. The present invention strives to develop new methodology for solving such nonlinear optimization problems in a computationally efficient manner which yields a powerful new technique for pattern recognition. The new method exploits the deep connections between Lie groups and their associated Lie algebras to transform the constrained nonlinear problems into equivalent unconstrained problems thereby significantly reducing the computational complexity. Lie groups have come to play an indispensable role in describing the symmetries of the electromagnetic, weak and strong nuclear interactions among elementary particles and, interestingly, appear to provide a natural, unifying framework for pattern recognition problems as well. Following the presentation of the new method, we illustrate its application in one of the pattern recognition problems, namely breast cancer diagnosis.

We focus on pattern recognition problems that have the following abstract structure. Conceptually, the pattern recognition problems of interest, have four main components.

1. A universe (space) of patterns, denoted S.

For example, the universe of patterns in the character recognition problem, S_{c}, would be the set of all one-dimensional figures that can be drawn on a plane or stated more mathematically, any 1-dimensional subset of R².

2. A real-valued function on S,

ƒ: S×S→[0, 1]

which computes for every Pᵢ, PⱼεS the correlation or overlap between Pᵢ and Pⱼ; ƒ(Pᵢ, Pⱼ)=1 if Pᵢ and Pⱼ are identical and ƒ(Pᵢ, Pⱼ)=0 if Pᵢ and Pⱼ have no overlap. The precise form of ƒ is problem-dependent.

For instance, in the character recognition problem if the input patterns Pᵢ and Pⱼ are represented as rectangular arrays of bits—with 1=black and 0=white—then, for example, ƒ(Pᵢ, Pⱼ) could be defined as the total number of array locations at which Pᵢ and Pⱼ have identical bit values, suitably normalized.

3. A subset [symbol] ⊂S of template patterns. Typically [symbol] is a finite set and can be written as

[symbol]

={ [symbol] ᵢ|iεI}.

In the character recognition problem for instance, the set of templates could be the set of upper-case letters in English alphabet.

4. Finally, one has a a group [symbol] of allowable deformations of the templates.

For instance, in the character recognition problem, examples of allowable deformations include translations (moving a character from one location to another), rotations, dilatations and arbitrary compositions thereof.

Given an input pattern [symbol] εS, the pattern recognition problem is to determine which of the template patterns, if any, [symbol] matches. To determine a match for [symbol] , one could compute for each template [symbol] ᵢε [symbol] the following function

$${C}_{P} ( {T}_{i} ) ≡ {max}_{g ∈ G} f ( g ( {T}_{i} ) , P )$$

That is, among all the allowable deformations of [symbol] ᵢ, g( [symbol] ᵢ), the above function picks that deformation that matches the given pattern [symbol] most closely. Next, one computes

$${M}_{P} ≡ {max}_{i ∈ I} {C}_{P} ( {T}_{i} )$$

If M [symbol] >τ, where τ is a prespecified threshold, then the given input pattern [symbol] is matched to that template [symbol] ⱼ for which C [symbol] ( [symbol] ⱼ)=M [symbol] .

The key problem in the above recognition procedure is

Maximize ƒ(g( [symbol] ᵢ), [symbol] )

S.T. gε [symbol] (1)

that is, maximizing the real-valued function ƒ over the group [symbol] . Since most of the deformation groups are Lie groups, we focus on Lie transformation groups hereafter. Before proceeding with the discussion though we digress slightly to draw into sharper focus the difficulty in solving (1) by considering a concrete example.

Consider the transformation group SO(n), whose n-dimensional matrix representation is the set

SO(n)={Mε [symbol] _{n×n}|M^{T}M=I; det(M)=1}

with the group operation being matrix multiplication; [symbol] _{n×n} is the space of all n×n real matrices. SO(n) can be parametrized in a straightforward way by treating the entries of MεSO(n), namely Mᵢⱼ, 1≦i, j≦n as the variables of the problem. Then (1) becomes,

$$\begin{matrix}Maximize & f ( {M}_{11} , … , {M}_{nn} ) \\ S . T . & {\sum }_{k = 1}^{n} {M}_{ik} {M}_{jk} = {δ}_{ij} ; 1 \leq i , j \leq n \\ & det ( M ) = 1\end{matrix} \qquad ( 2 )$$

where δᵢⱼ=1 if i=j and δᵢⱼ=0 otherwise. The optimization problem in (2) has n² quadratic equality constraints and one degree-n polynomial equality constraint. Such nonlinear equality constraints present an inherent difficulty to optimization algorithms, as illustrated in Figure ??. The feasible region of (2)—i.e., the set of points in Rⁿ^{²} that satisfy the n²+1 constraints—is a surface in Rⁿ^{²} and its dimension is less than n²; in the figure the shown surface represents the feasible region.

Assume that xₖ=(Mₗₗ^{(k)}, . . . , Mₙₙ^{(k)} is the k^{th} feasible point of (1), generated by the algorithm. Let ∇ƒ(xₖ) denote the gradient of ƒ at xₖ. If, as shown in Figure ??, neither ∇ƒ(xₖ) nor Π(xₖ), the projection of ∇ƒ(xₖ) onto the plane tangent to the feasible region at xₖ, are feasible directions, then any move along ∇ƒ(xₖ) or Π(xₖ) takes the algorithm out of the feasible region. When faced with this situation, typically a nonlinear programming algorithm moves along Π(xₖ) to a point such as yₖ. Subsequently, the algorithm moves along the direction perpendicular to Π(xₖ) to a feasible point on the constraint surface, such as xₖ₊₁.

The task of moving from an infeasible point such as yₖ to a feasible point such as xₖ₊₁ is computationally quite expensive since it involves a solving a system of nonlinear equations¹. In addition, in the presence of nonlinear constraints, there is the problem of determining the optimal step size; for instance, as shown in FIG. 2, the form of the constraint surface near xₖ could greatly reduce the step-size in the projected gradient method. Certainly, by choosing xₖ₊₁ to be sufficiently close to xₖ it is possible to ensure feasibility of xₖ₊₁; however such a choice would lead to only a minor improvement in the objective function and would be algorithmically inefficient. ¹It should be remarked that not all nonlinear programming methods attempt to maintain feasibility as described above. Methods such as the above, that attempt to manifestly maintain feasibility are called primal method in the literature. Apart from their competitive convergence rates, primal methods have many other attractive features. For instance, as is often the case in practical computation, if search is terminated before reaching the optimal solution, (in a primal algorithm) one is still at a feasible point that, though not optimal, could be acceptably close to an optimal solution. Secondly, the global convergence properties of most primal algorithms are quite satisfactory. Finally, primal methods do not require that the feasible region be convex and hence have a broader range of applicability. The computational overheads, incurred for maintaining feasibility in primal algorithms, persist in nonprimal methods as well, albeit in a different guise.

In summary, whenever the feasible region is a low-dimensional differentiable manifold (surface), the problem of maintaining feasibility constitutes a significant computational overhead. These computational overheads not only slow down the algorithm, but also introduce considerable numerical inaccuracies. For these reasons, optimization with nonlinear equality constraints is generally regarded as one of the most intractable problems in optimization.

However, when the nonlinear constraints come from an underlying transformation group, as they do in pattern recognition, we show that one can exploit the rich differential geometric structure of these groups to reduce the computational complexity significantly. As the breast cancer diagnosis example demonstrates, the reduction in computational complexity is quite dramatic.

We recall that an n-dimensional differentiable manifold [symbol] is a topological space together with an atlas {(Uᵢ, Φᵢ), iεI}, such that Uᵢ⊂ [symbol] , ∪ᵢUᵢ= [symbol] ,

Φᵢ: Uᵢ→Rⁿ,

and Φᵢ∘Φⱼ⁻¹ is C^{∞} for all i, j in the index set I. A real Lie group G is a set that is

1. a group

2. a differentiable manifold such that the group composition and inverse are C^{∞} operations. That is, the functions ƒ₁ and ƒ₂ defined as

ƒ₁: G×G→G; ƒ₁(g₁, g₂)≡g₁∘g₂, g₁, g₂εG (a)

ƒ₂: G→G; ƒ₂(g)≡g⁻¹, gεG (b)

are both C^{∞}.

Since a Lie group G is a differentiable manifold, we can talk about the tangent space to the manifold at any point and in particular the tangent space to the manifold at the identity element of the group, TₑG. The tangent space at the identity plays a crucial role in Lie group theory in that it encodes many of the properties of the Lie group including such global topological properties as compactness. As discussed below, TₑG has the structure of a Lie algebra and is called the Lie algebra of the Lie group. The rich structure of TₑG arises from the group structure of the underlying manifold. We start with the definition of a Lie algebra.

A Lie Algebra g is a vector space over a field F on which the Lie bracket operation [,] having the following properties is defined. For all X, Y, Zεg and α, βεF,

1. Closure: [X, Y]εg.

2. Distributivity: [X, αY+βZ]=α[X, Y]+β[X, Z]

3. Skew symmetry: [X, Y]=−[Y, X].

4. Jacobi identity: [X, [Y, Z]]+[Z, [X, Y]]+[Y, [Z, X]]=0

In order to explain why TₑG inherits the structure of a Lie algebra from G, we consider the algebra of vector fields on G.

If gεG is a group element we let

L_{g}: G→G

denote the diffeomorphism induced by left translation with g; L_{g}(g₁)≡gg₁. Let

L_{g*}: TₚG→T_{gp}G

denote the “push-forward” map induced by the diffeomorphism L_{g}. Then a vector field X on G is said to be left-invariant if L_{g*}X=X for all gεG. Clearly, left-invariance is a very strong condition on a vector field. A critical fact is that if two vector fields X, Y are left-invariant, then so is their commutator [X, Y]. The previous assertion is actually a consequence of the following more general fact: If

h: M→N

is a diffeomorphism between two n-manifolds M and N and X₁, X₂ two smooth vector fields on M, then

L_{h*}[X₁, X₂]=[L_{h*}X₁, L_{h*}X₂].

To prove this claim, note that if ƒ is a real-valued function defined on N, then

L_{h*}X[ƒ]∘h=X[ƒ∘h].

Defining

Yᵢ≡L_{h*}Xᵢ, i=1, 2

we have

(Y₁Y₂−Y₂Y₁)[ƒ]∘h=X₁[Y₂[ƒ]∘h]−X₂[Y₁[ƒ]∘h]=[X₁, X₂]∘[ƒh].

Hence if X₁ and X₂ are two left-invariant vector fields on a manifold M, then so is their commutator [X₁, X₂]. The other three conditions (i.e., distributivity, skew symmetry and Jacobi identity) are easily verified and we conclude that the set L(G) of all the left-invariant vector fields on a manifold M forms a Lie algebra called the Lie algebra of the Lie group G. The dimension of the Lie algebra (regarded as a vector space) is elucidated by an important result, which asserts that there is an isomorphism

i: TₑG→L(G)

between L(G) and TₑG. Hence the dimension of the Lie algebra of G is the same as the dimension of the n-manifold G, namely n. It is in this sense that the tangent space of the manifold at the identity element e, can be regarded as the Lie algebra of the manifold.

There is a subtle point to be emphasized here. In order to define TₑG to be a Lie algebra, we need to define a Lie bracket operation on the vector space TₑG. Since the commutator of two (left-invariant) vector fields is also a (left-invariant) vector field the Lie bracket on TₑG is constructed using the commutator on the left-invariant vector fields using the isomorphism i. Let {V₁, . . . , Vₙ} be a basis for the vector space L(G)≅TₑG. Then the commutator of any two vector fields Vᵢ, VⱼεL(G) must be a linear combination of them. Hence we may write,

$$[ {V}_{i} , {V}_{j} ] = {\sum }_{γ = 1}^{n} {C}_{α β}^{γ} {V}_{γ}$$

where C^{r}_{α,β} are called the structure constants of the Lie algebra.

We now come to a result of central importance in the theory of Lie groups. We recall that a vector field on a manifold M is said to be complete if the integral curve

σ: R→M,

is defined over the entire real line². The key result of Lie group theory is that every left-invariant vector field on a Lie group is complete—a property of crucial importance in optimization. To prove the claim, consider

σ_{ε}: [−_{ε}, _{ε}]→G,

the integral curve of the given left-invariant vector field X defined on the Lie manifold G. Further, let σ_{ε}(0)=e, the identity of G. Now consider

σ_{2ε}: [−2_{ε}, 2_{ε}]→G

defined as

$${σ}_{2 ε} ( s ) ≡ \{ \begin{matrix}{σ}_{ε} ( - ε ) {σ}_{ε} ( s + ε ) & if - 2 ε \leq s \leq ε \\ {σ}_{ε} ( s ) & if - ε \leq s \leq ε \\ {σ}_{ε} ( ε ) {σ}_{ε} ( s - ε ) & if ε \leq s \leq 2 ε\end{matrix}$$

²A simple example of incomplete vector field would be the vector field V(x)=x² defined over the 1-dimensional manifold R. Integral curves of this vector field are of the form

$$σ ( t ) = \frac{1}{C - t} ,$$

where the constant C depends on the initial condition σ(0). Clearly, regardless of what value C takes the integral curve is not defined over the entire real line.

In order to prove the claim it is sufficient to show that σ₂_{_{ε}} defined above is an integral curve of X. Consider ε<S*≦2_{ε}. Since X is left-invariant, X_{σ2}_{_{ε}}^{(S*)} is tangent to σ_{2ε}(S*) and hence σ₂_{_{ε}} is an integral curve of X defined over [−2_{ε}, 2_{ε}]. Repeating this argument, we see that, using the group structure of G, one can consistently extend σ_{ε} to be defined over the entire real line R.

The bijection between the space of left-invariant vector fields, L(G), and the tangent space at identity, TₑG, implies that given any tangent vector AεTₑG, we can construct a left-invariant vector X_{A} corresponding to it. The completeness of X_{A} then allows us to consistently extend any local integral curve of X_{A} passing through the identity, and obtain an integral curve of X_{A} defined over the entire real line R. The integral curve so obtained is clearly a homomorphism from the additive group R to the Lie group G and is hence a one-parameter subgroup of G. Therefore, we obtain the following map, called the exponential map (due to the aforementioned homomorphism)

exp: R×TₑG→G (3)

which defines, for a given AεTₑG, an integral curve σ_{A}(t) of the left-invariant vector field X_{A}, with σ_{A}(0)=e. The existence of such an exponential map accords an efficient way to maintain feasibility as the algorithm traverses the manifold G.

These and other features and advantages of the present invention will be further understood upon consideration of the following detailed description of an embodiment of the present invention, taken in conjunction with the accompanying drawings.

### 4 BRIEF DESCRIPTION OF THE DRAWINGS

FIG. 1 illustrates an example of a projected gradient method on a curved constraint surface; and

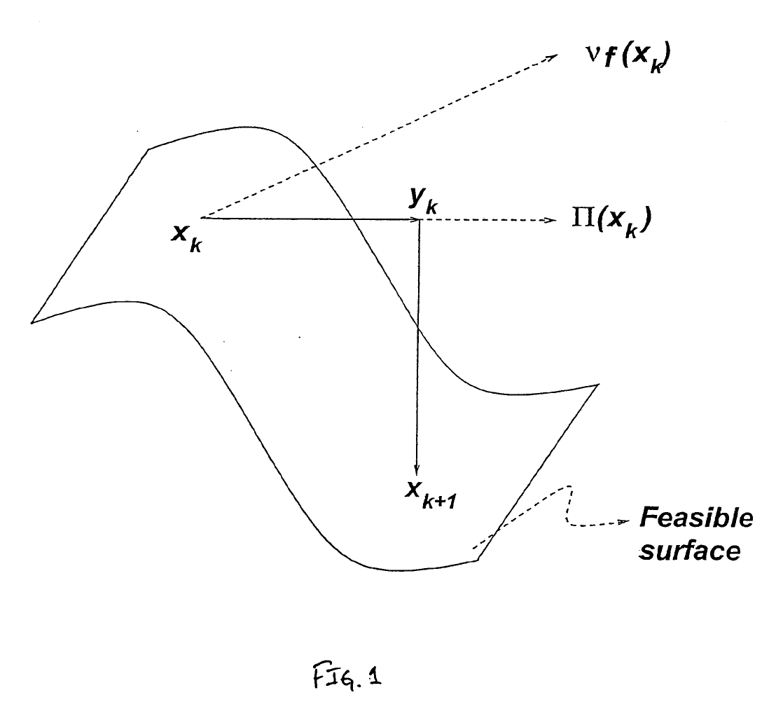

FIG. 2 illustrates a small step size in a projected gradient method.

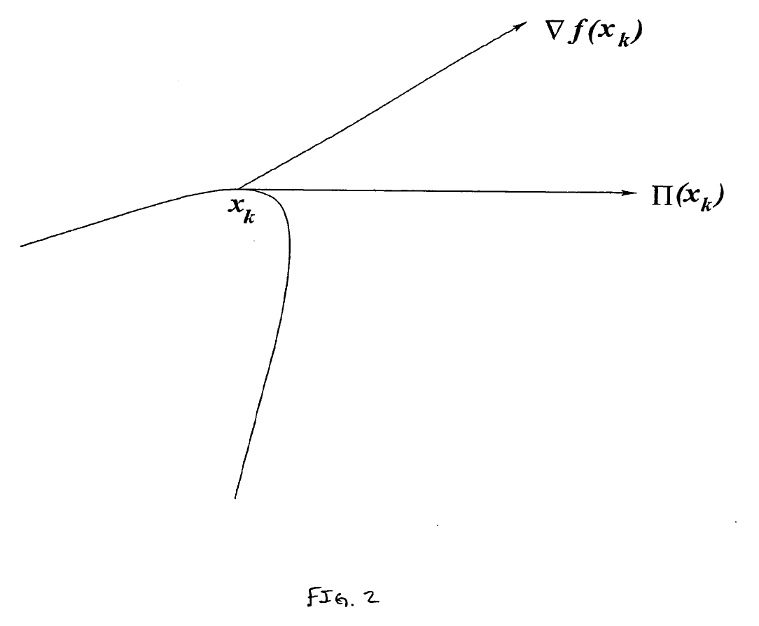

### 5 DETAILED DESCRIPTION OF THE PRESENTLY PREFERRED EMBODIMENTS

We now consider the problem of optimizing a real-valued function

h: G→R

defined over a Lie manifold G. In this section, we'll present the general method and discuss some geometric and computational aspects of the method. In the next section, we'll present details of how the method can be adapted to solve pattern recognition problems. As an illustration of how the theory can be applied in the real-world and also to demonstrate the practical value of the method, we'll describe in detail one application—breast cancer diagnosis—in which we were able to achieve significant speedup in computation by exploiting the Lie group techniques discussed in this paper.

For concreteness, in the following discussion, we'll work with a matrix representation of the Lie group G By a matrix representation of G we mean a homomorphism

h: G→Mₙ

where Mₙ is the space of all real n×n matrices. Hence, ∀g₁, g₂εG, h(g₁∘g₂)=h(g₁)·h(g₂); g₁∘g₂ denotes group composition while h(g₁)·h(g₂) is the ordinary matrix multiplication. Also, we'll supplement the following discussion for a general Lie group with a parallel illustration of how the method works for a specific Lie group, namely SO(n).

We start with a brief discussion of the Special Orthogonal group SO(n). An n×n matrix A, with the property that AA^{T}=I is called an orthogonal matrix. SO(n) is the multiplicative Lie group of all n×n orthogonal matrices. Since SO(n) is a proper subgroup of Mₙ, the set of all n×n real matrices, the manifold SO(n) naturally embeds in the n²-dimensional space Rⁿ^{²}. Further if A is an n×n orthogonal matrix, and aᵢⱼ, the (i, j)^{th} element of A, then AA^{T}=I implies that

$${\sum }_{i , j = 1}^{n} {a}_{i , j}^{2} = n .$$

In other words, SO(n) is a submanifold of the (n²−1)-dimensional sphere Sⁿ^{²}₋₁.

In order to define the exponential map on SO(n) we need the Lie algebra of the group. To obtain the Lie algebra, we compute the tangent vectors to the manifold at the identity of the group. Thus, let M(t),−ε<t<ε, be a curve on the manifold passing through the identity I at t=0 (M(t) is an n×n orthogonal matrix and M(0)=I). For sufficiently small t, we can expand M(t) in a Taylor series to get

M(t)=I+tM′(0)+O(t²)

Since M(t)M(t)^{T}=I, we have

$$\begin{matrix}( I + {tM}^{′} ( 0 ) + O ( {t}^{2} ) ) {( I + {tM}^{′} ( 0 ) + O ( {t}^{2} ) )}^{T} = I + t [ {M}^{′} ( 0 ) + {{M}^{′} ( 0 )}^{T} ] + \\ O ( {t}^{2} ) \\ = I\end{matrix}$$

Therefore, to O(t), we have

M′(0)+M′(0)^{T}=0 [symbol] M′(0)=−M′(0)^{T}

or M′(0), the tangent vector at identity is an antisymmetric matrix.

The Lie algebra of SO(n) then is the vector space of all n×n antisymmetric matrices. If we take the Lie bracket operation to be the matrix commutator, it is easily verified that all the four conditions—closure, distributivity, skew symmetry and Jacobi identity—are satisfied. The exponential map (3) is just the matrix exponentiation. If A is any n×n antisymmetric matrix, exp(A) is defined as

$$exp ( A ) ≡ {\sum }_{j = 0}^{∞} \frac{{A}^{n}}{n !}$$

To verify that, if A is an antisymmetric matrix then exp(A) is indeed a proper orthogonal matrix with unit determinant, consider

$${[ exp ( A ) ]}^{T} = {\sum }_{j = 0}^{∞} \frac{{( {A}^{T} )}^{n}}{n !} = {\sum }_{j = 0}^{∞} \frac{{( - A )}^{n}}{n !} = exp ( - A )$$

Hence exp(A) [exp(A)]^{T}=I and exp(A)εSO(n). The canonical basis for the Lie algebra of SO(n) is the set of matrices A^{(r, s)}, 1≦r<s≦n, where the (i, j)^{th} element of A^{(r, s)}, 1≦i, j≦n is

$${A}^{( r , s )} ( i , j ) ≡ \{ \begin{matrix}1 & if r = i and s = j \\ - 1 & if r = j and s = i \\ 0 & otherwise\end{matrix}$$

Any antisymmetric matrix A can be expressed in terms of the canonical basis as

$$A = {\sum }_{1 \leq r < s \leq n} {C}_{r , s} {A}^{( r , s )} .$$

Also, every special orthogonal matrix can be written as the exponential of an antisymmetric matrix. Therefore, the space of special orthogonal matrices can be parametrized by the

$$\frac{{n}^{2} - n}{2}$$

coefficients C_{r, s} where −∞<C_{r, s}<∞, 1≦r<s≦n as

$$ω : {R}^{\frac{{n}^{2} - n}{2}} -> SO ( n )$$

$$where$$

$$ω ( {x}_{1 , 2} , … , {x}_{n - 1 , n} ) ≡ exp ( {\sum }_{1 \leq r \leq s \leq n} {x}_{r , s} {A}^{( r , s )} ) .$$

Hence given a function

h: SO(n)→R

we could compose it with the map ω to define a new function

$$f : {R}^{\frac{{n}^{2} - n}{2}} -> R ;$$

ƒ≡h ∘ω

defined over all of

$${R}^{\frac{{n}^{2} - n}{2}} .$$

Now if our problem is

Maximize h(x) (4)

S.T. xεSO(n) (5)

in order to optimize h over SO(n) we could just as well optimize ƒ over

$${R}^{\frac{{n}^{2} - n}{2}} .$$

Let

$${z}^{*} ∈ {R}^{\frac{{n}^{2} - n}{2}}$$

be the optimizer of ƒ. Then the optimal solution of the problem (5) would be ω(z*).

Against the backdrop of the foregoing discussion, we present the general algorithm for solving the following optimization problem: Maximize h(x) S.T. xεG; G: a connected Lie n-manifold

Algorithm:

1. Let [symbol] be the Lie algebra of G and V₁, . . . , Vₘ, a basis of the Lie algebra. Define the map

ω: R^{m}→G; ω(x₁, . . . , xₘ)≡exp(x₁ V₁+ . . . +xₘ Vₘ)

2. Start the algorithm at

g⁽⁰⁾←eεG

and the set the iteration counter

i←0.

3. Define

Ωᵢ: R^{m}→R; Ωᵢ(x₁, . . . , xₘ)≡h(g⁽ⁱ⁾∘ω(x₁, . . . , xₘ)).

4. If ∇Ωᵢ(0)=0 then STOP; g⁽ⁱ⁾ is the optimal solution.

Else, maximize the function Ωᵢ on the line passing through the origin along the direction ∇Ωᵢ(0). Let the (local) maximum occur at the point z*ᵢεR^{m}. Set

g⁽ⁱ⁺¹⁾←g⁽ⁱ⁾∘ω(z*ᵢ)

i←i+1

Go to step 3.

There are several aspects of the above algorithm that warrant elaboration. We elaborate on some important issues in the following subsections.

5.1 Optimization on One-parameter Subgroups

In optimizing a real-valued function over a Euclidean domain, in each iteration, one usually employs a line-search routine to improve the objective function value. That is, if X^{(k)} is the k^{th} iterate, and ƒ(X), the objective function to be maximized, then one maximizes the function

g(t)≡ƒ(X^{(k)}+t∇ƒ(X^{(k)})).

If the maximizer of g(t) is t*, then

X^{(k+1)}←X^{(k)}+t* ∇ƒ(X^{(k)}).

Unlike in the Euclidean spaces, on curved Lie manifolds one doesn't have straight lines. So the above procedure of optimizing g(t) over the straight line (parallel to ∇ƒ(X^{(k)})) has to be adapted to work on a curved manifold. On Lie manifolds, instead of searching over a straight line passing through the k^{th} iterate g^{(k)}εG, we search over a one-parameter subgroup (curve) passing through g^{(k)}. Just as one chooses ∇ƒ(X^{(k)}) as the locally optimal direction in a Euclidean space, on a curved manifold, one chooses the locally optimal curve from among the infinite continuum of curves passing through g^{(k)} as follows.

Consider the diffeomorphism

L_{g}^{(k)}: G→G; L_{g}^{(k)}(g)=g^{(k)}∘g

induced by the left translation by g^{(k)}. If U is a neighborhood containing the identity element e, then W=L_{g}^{(k)} (U) is a neighborhood containing g^{(k)}. If [symbol] is the Lie algebra of G, then since the map

exp: [symbol] →G

is diffeomorphic in a sufficiently small neighborhood of the origin in [symbol] , we can find a neighborhood V⊂ [symbol] such that 0εV and

exp: V→U

is a diffeomorphism. Thus we obtain the following sequence of diffeomorphisms

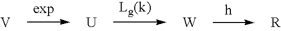

Given the above diffeomorphisms, finding the curve in W that is locally optimal for the function h is equivalent to finding the curve in U that is locally optimal for the function h∘L_{g}^{(k)} which in turn is equivalent to finding in V, the direction locally optimal to the function

ƒ(x₁, . . . , xₘ)≡h∘L_{g}^{(k)}∘ exp(x₁e₁+ . . . +xₘeₘ)

where e₁, . . . , eₙ form a basis of the Lie algebra [symbol] .

In other words, the curve in W locally optimal for the function h, is the image under L_{g}^{(k)}∘ exp of the line through 0ε [symbol] in the direction ∇ƒ(0), that is the curve

σ: R→G; σ(t)≡L_{g}^{(k)} [exp [t.∇ƒ(0)]].

Observe that σ(0)=g^{(k)} and hence σ passes through g^{(k)}.

Thus using the exponential map and the group structure of the manifold, we could reduce the problem of optimizing h over the curve σ to the much more tractable problem of optimizing the function ƒ over the line {t∇ƒ(0)|−∞<t<∞} in Rⁿ.

5.2 Gradient in an Internal Space

Let the Lie manifold G be embedded in Euclidean space R^{k} (i.e., G⊂R^{k}). Then G inherits a coordinatization from R^{k} due to the embedding

Φ: G→R^{k}

For any gεG, Φ(g)εR^{k}, and we'll call Φ, the Euclidean coordinate system on G. G can also be coordinatized using the exponential map as follows. If g=exp(a₁e₁+ . . . +aₙeₙ), then we define

ψ: G→Rⁿ; ψ(g)=(a₁, . . . , aₙ)

and call ψ the canonical coordinate system on G.

In order to minimize the real-valued function

h: G→R,

unlike conventional nonlinear programming algorithms, we do not use the gradient of the function

h_{Φ}: R^{k}→R; h_{Φ}≡h∘Φ

to move to the next iterate in the algorithm. To be very precise, h is not even defined on R^{k}\Φ(G) and hence we cannot talk about the gradient. Even if there is a natural embedding of G in R^{k} and h is defined over all of R^{k}, as in most nonlinear programs, moving along ∇h_{Φ} is undesirable. Moving along ∇h_{Φ} is the reason that the conventional NLP algorithms leave the feasible region (and consequently expend considerable effort to restore feasibility).

In contrast, we use the locally optimal direction in an abstract internal space (of the Lie algebra) to move to the next iterate in each step. Specifically, as discussed above, we use the gradient of the pull-back function

h_{ψ}: Rⁿ→R; h_{ψ}≡h∘ψ

and move along the curve on G tangent to ∇h_{ψ} by exponentiating the gradient. As discussed above, such a scheme enables us to improve the objective function monotonically while remaining on the manifold at all times. This switch from the Euclidean gradient to the gradient in the internal Lie algebra space is the crucial departure of our method from conventional nonlinear optimization methods.

5.3 Computing Matrix Exponents

In iteration k of the algorithm we maximize the function h over the curve σ(t) which passes through g^{(k)}. In order to compute points on the curve one needs to exponentiate a vector of the Lie algebra, or if one works with matrix representations of Lie groups as we do, one needs to exponentiate a square matrix. Representing the manifold as the image of the Lie algebra under the exponential map lies at the heart of the Lie group approach to optimization. In fact, the exponentiation operation allows us to move along curves on the manifold and manifestly maintain feasibility at all times. Thus, it is particularly important that the computation of a matrix exponent be extremely accurate lest the algorithm should stray away from the manifold (and thus lose one of its attractive features). Also, since the matrix exponent will be computed repeatedly as we optimize on a curve, it is particularly important that we use a very fast subroutine for matrix exponentiation. In this subsection we take a closer look at the problem of computing matrix exponents.

Computing the exponent of a square matrix is a very old and fundamental problem in computational Linear Algebra. The importance of matrix exponentiation has to do with its role in solving a system of first order ordinary differential equations (ODE)

$$\frac{ⅆ X}{ⅆ t} = AX ;$$

The solution of the system is

X(t)=e^{At}X₀

Due to their central role in the solution of ODE the problem of computing matrix exponents has been extensively investigated.

We begin by looking at the simplest method. Since

$${e}^{A} = I + A + \frac{{A}^{2}}{2 !} + …$$

a straightforward method would be to sum the Taylor series until the addition of another term does not alter the numbers stored in the computer. Such a method, though simple to implement is known to yield, when the floating point precision is not very large, wildly inaccurate answers due to cancellations in the intermediate steps of the summation. However, if the precision of the floating point arithmetic is sufficiently large, it is a fairly reliable procedure. If we define

$${T}_{k} ( A ) = {\sum }_{j = 0}^{k} \frac{{A}^{j}}{j !}$$

then the following estimate of the error resulting from truncation of Taylor series

$$‖ {T}_{k} ( A ) - {e}^{A} ‖ \leq ( \frac{{‖ A ‖}^{k + 1}}{( k + 1 ) !} ) ( \frac{1}{1 - \frac{‖ A ‖}{( k + 2 )}} )$$

suggests that in order to obtain an answer within a tolerance δ, series should be summed to at least k terms where

$$( \frac{{‖ A ‖}^{k + 1}}{( k + 1 ) !} ) ( \frac{1}{1 - \frac{‖ A ‖}{( k + 2 )}} ) \leq δ .$$

(||A|| denotes the norm of the matrix A.)

The Padé approximation to e^{A} generalizes the above straightforward summation of the Taylor series. Specifically, the (p, q) Padé approximation to e^{A} is defined as

R_{pq}(A)=[D_{pq}(A)]⁻¹N_{pq}(A)

where

$${N}_{pq} ( A ) = {\sum }_{j = 0}^{p} \frac{( p + q - j ) ! p !}{( p + q ) ! j ! ( p - j ) !} {A}^{j}$$

$${D}_{pq} ( A ) = {\sum }_{j = 0}^{q} \frac{( p + q - j ) ! q !}{( p + q ) ! j ! ( q - j ) !} {( - A )}^{j}$$

Padé approximation reduces to Taylor series when q=0 and p→∞. Just like in the Taylor series, round-off errors is a serious problem in Padé approximant as well.

The round-off errors in Taylor approximation as well as Padé approximation can be controlled by using the following identity:

e^{A}=(e^{A/m)}^{m}

If one chooses m to be a sufficiently large power of 2 to make

$$\frac{‖ A ‖}{m} \leq 1$$

then e^{A/m} can be satisfactorily computed using either the Taylor or the Padé approximants. The resulting matrix is then repeatedly squared to yield e^{A}. This method of computing e^{A/m} followed by repeated squaring is generally considered to be the best method for computing the exponent of a general matrix. Ward's program which implements this method is currently among the best available.

To compute matrix exponents one could also use the the very powerful and sophisticated numerical integration packages that have been developed over the years to solve ordinary differential equations. The advantages of using these codes are that they give extremely accurate answers, are very easy to use requiring little additional effort and are widely available in most mathematical computing libraries (eg., MATLAB, MATHEMATICA and MAPLE). The main disadvantage is that the programs will not exploit the structure of the matrix A and could require a large amount of computer time. See references in for details.

The above methods for computing the matrix exponent do not exploit any of the special features of the matrix. In Lie group theory, matrices in the Lie algebra usually have very nice properties that can be exploited to compute the exponent very efficiently. For instance, the Lie algebra of SO(n) is the vector space of antisymmetric matrices. If A is an antisymmetric matrix, then iA is a Hermitian matrix and hence iA can be diagonalized by a unitary matrix as

$$iA = {U}^{H} Λ U ; \qquad Λ = [ \begin{matrix}{λ}_{1} & & \\ & ⋰ & \\ & & {λ}_{n}\end{matrix} ] ; \qquad {λ}_{1} , … , {λ}_{n} \text{:} real$$

where U^{H} represents the Hermitian conjugate of U. The columns of U are the eigenvectors of iA and λ₁, . . . , λₙ are its eigenvalues. Therefore

$${e}^{At} = {U}^{H} [ \begin{matrix}{ⅇ}^{- ⅈ {λ}_{1} t} & & \\ & ⋰ & \\ & & {ⅇ}^{- ⅈ {λ}_{n} t}\end{matrix} ] U$$

Thus, in order to compute e^{At} it suffices to compute the eigenvalues and eigenvectors of the Hermitian matrix iA. This is a particularly appealing scheme since it yields a closed form expression for the curve σ(t)≡e^{At}. The limitation of this approach is that it works only when the matrix or a constant multiple of it is diagonalizable. Another serious drawback of this procedure is that it is very inaccurate when the matrix of eigenvectors is nearly singular; if the diagonalizing matrix is nearly singular it is very ill-conditioned and the computation is not numerically stable. Not all matrices however are even diagonalizable. Oftentimes a matrix does not have a complete set of linearly independent eigenvectors—i.e., the matrix is defective. When the matrix A is defective, one can use a Jordan canonical decomposition as

A=P[J₁⊕J₂⊕ . . . ⊕Jₖ]P⁻¹

where

$${J}_{i} = [ \begin{matrix}{λ}_{i} & 1 & & & \\ & {λ}_{i} & 1 & & \\ & & ⋰ & ⋰ & \\ & & & {λ}_{i} & 1 \\ & & & & {λ}_{i}\end{matrix} ]$$

where λᵢ are the eigenvalues of A. Then

e^{At}=P[e^{J}₁^{t}⊕ . . . ⊕e^{J}ₖ^{t}]P⁻¹

If the matrix Jᵢ is (m+1)×(m+1) then e^{J}ᵢ^{t} is easily computed to be

$${ⅇ}^{{J}_{i} t} = {ⅇ}^{{λ}_{i} t} [ \begin{matrix}1 & t & \frac{{t}^{2}}{2 !} & … & & \frac{{t}^{m}}{m !} \\ & 1 & t & … & & \frac{{t}^{m - 1}}{( m - 1 ) !} \\ & & & ⋰ & & ⋮ \\ & & & & 1 & t \\ & & & & & 1\end{matrix} ]$$

However computing the Jordan canonical form is not computationally very practical since rounding errors in floating point computation could make multiple eigenvalue to split into distinct eigenvalues or vice versa, thereby completely altering the structure of the Jordan canonical form. Refinements of the Jordan decomposition namely, the Schur decomposition and the general block diagonal decomposition schemes overcome many of the shortcomings of the Jordan decomposition scheme and are quite competitive in practice.

Finally, we mention a rather interesting procedure for matrix exponentiation that works for an arbitrary matrix. While, for two matrices B and C,

e^{B}e^{C}≠e^{B+C}

unless BC=CB, Trotter product formula states that

$${e}^{B + C} = {lim}_{m \to ∞} {( {e}^{\frac{B}{m}} {e}^{\frac{C}{m}} )}^{m}$$

Thus for sufficiently large m, one could write

$${e}^{B + C} ≃ {( {e}^{\frac{B}{m}} {e}^{\frac{C}{m}} )}^{m}$$

Such a scheme is attractive when e^{B/m} and e^{C/m} are easily computable. Now given a matrix A, one could decompose it into a sum of symmetric and antisymmetric matrices as

$$A = \underbrace{\frac{1}{2} [ A + {A}^{T} ]}_{B} + \underbrace{\frac{1}{2} [ A - {A}^{T} ]}_{C}$$

One could then compute e^{B/m} and e^{C/m} by diagonalizing the symmetric and antisymmetric matrices as discussed above. Choosing m to be a suitably large power of 2 then enables one to compute e^{A} by repeated squaring. It has been shown that

$$\begin{matrix}‖ {e}^{A} - {( {e}^{\frac{B}{m}} {e}^{\frac{C}{m}} )}^{m} ‖ \leq \frac{‖ [ {A}^{T} , A ] ‖}{4 m} {ⅇ}^{μ ( A )} \\ where \\ μ ( A ) = max \{ μ \vert μ is an eigenvalue of \frac{A + {A}^{H}}{2} \} .\end{matrix}$$

Thus by choosing the parameter m to be sufficiently large the computation can be made arbitrarily accurate. Since the eigenvalue decomposition is a fairly efficient process, this method is very promising.

5.4 Weak Exponentiality

In the presentation of the algorithm and the foregoing discussion we have implicitly assumed that every element gεG can be written as g=exp(A) for some Aε [symbol] ( [symbol] is the Lie algebra of G). The above assumption of surjectivity of the exponential map requires elaboration.

We start with a few definitions. A Lie manifold is said to be an exponential Lie manifold if the exponential map exp: [symbol] →G is surjective; G is said to be weakly exponential if G is the closure of exp( [symbol] ), i.e.,

\overline{exp [symbol]}=G.

In nonlinear optimization algorithms one usually terminates the computation when the algorithm gets inside an ε-neighborhood of the optimal solution (for some prespecified tolerance ε). Hence, excluding any subset of codimension one or higher in the feasible region, has no algorithmic consequence. Therefore, the distinction between exponentiality and weak exponentiality of Lie manifolds is unimportant for our purposes; in this paper our interest really is in weakly exponential Lie manifolds.

It should be remarked that the distinction between exponentiality and weak exponentiality, though unimportant from our perspective, is extremely important mathematically. To this day, the problem of classifying all exponential Lie groups remains one of the most important unsolved problems in Lie group theory; in contrast, weakly exponential Lie groups have been fully classified. Exponentiality of Lie groups has been studied in the case of simply connected solvable Lie groups, connected solvable Lie groups, classical matrix groups, centerless groups, algebraic groups and complex splittable groups. In contrast, it is known that a Lie group is weakly exponential if and only if all of its Cartan subgroups are connected; this class includes all the Lie groups of interest to us and hence we implicitly assumed weak exponentiality in the foregoing discussion.

To be accurate, all of the foregoing discussion, including the algorithm, applies to the class of weakly exponential Lie groups. We conclude this remark by showing an example of a curve in a Lie manifold G that does not intersect the image exp( [symbol] ) (where as usual [symbol] is the Lie algebra of G).

Consider SL(2, R), the Lie group of all real 2×2 matrices with unit determinant. Let M(t) be a curve on SL(2, R), −ε<t<ε, M(0)=I, det(M(t))=1. M(t) can be written as

$$\begin{matrix}M ( t ) = I + {tM}^{′} ( 0 ) + O ( {t}^{2} ) \\ ≡ [ \begin{matrix}1 & 0 \\ 0 & 1\end{matrix} ] + t [ \begin{matrix}a & b \\ c & d\end{matrix} ] + O ( {t}^{2} ) .\end{matrix}$$

Therefore,

det(M(t))=1+t(a+d)+O(t²)

which implies that

a+d=0

or the tangent vector is a real traceless 2×2 matrix. Conversely, if A is a real traceless 2×2 matrix define

M≡exp(A)=>A=1n M

Recalling that

det(M)=e^{Trace}_{(1n M)}

we see that the exponential of a traceless 2×2 matrix belongs to SL(2, R). Thus the Lie algebra of SL(2, R), denoted sl(2, R) is the vector space of all traceless 2×2 matrices. One basis of sl(2, R) is the following set of matrices:

$$[ \begin{matrix}1 & 0 \\ 0 & - 1\end{matrix} ] , \qquad [ \begin{matrix}0 & 1 \\ 0 & 0\end{matrix} ] , \qquad [ \begin{matrix}0 & 0 \\ 1 & 0\end{matrix} ] .$$

A general element of sl(2, R) is

$$A = [ \begin{matrix}a & b \\ c & - a\end{matrix} ] . \qquad ( 6 )$$

If Aεsl(2, R), then it is easy to verify that A²=−det(A)I. Hence if we define β=\sqrt{det(A)} we have

$$exp ( A ) = cos ( β ) I + \frac{sin β}{β} A \qquad ( 7 )$$

For any λ<0, λ≠1, we see that the matrix

$$B = [ \begin{matrix}λ & 0 \\ 0 & {λ}^{- 1}\end{matrix} ]$$

belongs to SL(2, R). Now if exp(A)=B, from (6) and (7) we know that b=c=0. It is now easy to verify that

$$exp A = ( \begin{matrix}cosh ( a ) + sinh ( a ) & 0 \\ 0 & cosh ( a ) - sinh ( a )\end{matrix} )$$

While det(A)=cos h²(a)−sin h²(a)=1,

cos h(a)+sin h(a)=e^{a}≮0; ∀a

Hence, although B belongs to SL(2, R), B≠A exp(A) for any Aε [symbol] . In fact, since B cannot be written as the exponent of a Lie algebra vector for any −∞<λ<−1 we have a curve in SL(2, R) which does not intersect exp( [symbol] ) as claimed.

6 An Application

The following application illustrates how the Lie group methodology can be used to solve problems in pattern recognition. After a brief presentation of the background we outline the optimization problem embedded in breast cancer diagnosis and discuss its solution.

In contrast to conventional biopsy, which is a surgical procedure, the technique of Fine Needle Aspiration (FNA) attempts extract a sample of the breast tumor using a needle. While a biopsy yields a sample of the tumor tissue—and hence both histological (tissue) and cytological (cell) information about the tumor—an FNA extract contains only the cytological information about the tumor since the tissue architecture is not preserved during the aspiration procedure. Thus, although FNA has a considerable advantage over biopsy in being a nonsurgical procedure, it is charged with a greater challenge of detecting malignancy without the benefit of histological data about the tumor. Studies show that there is considerable variation in the reliability of FNA-based visual diagnosis among pathologists. Efforts are currently underway to automate the FNA-based diagnosis procedure in order to (a) improve the diagnostic reliability and (b) detect the signature of malignancy before it becomes discernible to the human eye.

Statistical analyses have shown that the following nine cellular features distinguish benign tumors from malignant ones most effectively: uniformity of cell size, uniformity of cell shape, number of bare nuclei, number of normal nucleoli, frequency of mitosis, extent of bland chromatin, single epithelial cell size, marginal adhesion (cohesion of peripheral cells) and clump thickness (the extent to which epithelial cell aggregates are mono or multilayered). In each cytological tumor sample, integer values are assigned to these features so that higher numbers signal a higher probability of malignancy. Thus, for the purposes of diagnosis, each tumor sample is represented as a 9-dimensional integer vector. Given such a 9-dimensional feature vector of an undiagnosed tumor, the problem is to determine whether the tumor is benign or malignant.

Hundreds of such 9-dimensional feature vectors, from tumors with confirmed diagnosis, have been compiled in databases such as the Wisconsin Breast Cancer Database (WBCD). The approach currently in vogue is to use the vectors in these databases to partition the 9-dimensional feature space R⁹ into benign and malignant regions. An undiagnosed tumor is then diagnosed as benign if and only if its feature vector falls into the benign region. Various approaches have been pursued to partition the feature space as described above. Among the previous approaches, average diagnostic accuracy is particularly high in those approaches that partition R⁹ using nonlinear surfaces.

Our scheme to partition R⁹ repeatedly solves the following optimization problem.

Given m blue points B₁, . . . , BₘεR⁹ and n green points G₁, . . . , GₙεR⁹, obtain an ellipsoid that encloses the maximum number of blue points and no green points inside it.

In this optimization problem we are searching over the space of all ellipsoids to find the optimal ellipsoid. Recalling that the interior of an ellipsoid is given by the equation

(X−C)^{T} A(X−C)≦1

where CεR⁹ is the center of the ellipsoid and A a symmetric positive definite matrix, we realize that we are searching over the space of all pairs (A, C) where A is a 9×9 symmetric positive definite matrix and C a 9-dimensional vector.

In order to restrict the search to the space described above, we need to describe a feasible region such that every point inside the feasible region encodes a pair (A, C) as described above. In order to do so, we may recall that every symmetric matrix A can be diagonalized using an orthogonal matrix as

A=S^{T} ΛS

where S^{T} S=I and

$$Λ = [ \begin{matrix}{λ}_{1}^{2} & & \\ & ⋰ & \\ & & {λ}_{9}^{2}\end{matrix} ] ;$$

Thus if we used the entries in S, sᵢⱼ and the variables λ₁, . . . , λ₉ as the variables the optimization problem becomes

$$\begin{matrix}Maximize & f ( {s}_{ij} , {λ}_{k} , {c}_{r} ) & 1 \leq i , j , k , r \leq 9 \\ S . T . & {\sum }_{j = 1}^{9} {s}_{ij} {s}_{kj} = {δ}_{ik} & 1 \leq i \leq k \leq 9 \\ & {( {G}_{r} - C )}^{T} {S}^{T} Λ S ( {G}_{r} - C ) \geq 1 & 1 \leq r \leq m\end{matrix}$$

In the above formulation, ƒ(sᵢⱼ, λₖ, cᵣ) is an integer valued function that computes the number of blue points inside the ellipsoid (X−C)^{T} S^{T} ΛS(X_{C})≦1. One could absorb the constraint (Gᵣ−C)^{T} S^{T} ΛS(Gᵣ−C)≧1 into the objective function by imposing a heavy penalty on ellipsoids that enclose green points. If the new objective function is denoted h(sᵢⱼ, λₖ, cᵣ; Gᵣ) the optimization problem becomes

$$\begin{matrix}Maximize & h ( {s}_{ij} , {λ}_{k} , {c}_{r} ; {G}_{s} ) & 1 \leq i , j , k , r \leq 9 , 1 \leq s \leq n \\ S . T . & {\sum }_{j = 1}^{9} {s}_{ij} {s}_{kj} = {δ}_{ik} & 1 \leq i \leq k \leq 9\end{matrix}$$

The above Integer Nonlinear Program with 45 constraints is extremely difficult to solve. Conventional Nonlinear Programming software packages performed very poorly in solving such problems (in fact, most of the times the computation never ran to completion and when it did, the answers were often infeasible).

In the above problem computational efficiency can be improved dramatically by realizing that one was trying to optimize the integer valued function h over a product Lie manifold SO(9)×R⁹. Since the space of orthogonal 9×9 matrices is the Lie group SO(9), instead of parametrizing an orthogonal matrix S using its entries S, one can use the exponential map and parametrize SO(9) using antisymmetric matrices. That is, every 9×9 orthogonal matrix M can be written as

M=e^{A}

where A is an antisymmetric matrix. Instead of the variables sᵢⱼ 1≦i, j≦9, one then uses the entries of the antisymmetric matrix A, namely aₖₗ, 1≦k<l ≦9 as the variables. The change of variables from {sᵢⱼ} to {aₖₗ} has two consequences:

1. While sᵢⱼ have to satisfy the constraint

$${\sum }_{j = 1}^{9} {s}_{ij} {s}_{kj} = {δ}_{ik} ,$$

the variables aₖₗ are unrestricted (i.e., −∞<aₖₗ<∞). A constrained integer NLP is replaced by an unconstrained integer NLP!

2. The computation of the objective function becomes harder since one needs to exponentiate the antisymmetric matrix A to get the orthogonal matrix S.

It turns out that the extra effort for matrix exponentiation is far outweighed by the improved efficiency due to the parametrization of the group SO(9) in terms of its Lie algebra. Consequently, there was a significant speed-up in the computation; in contrast to the available optimization packages, a version of the method we implemented not only solves the problems in every case but does so at very impressive speeds.

7 Remarks

One of the extensions of the reported work that we are pursuing is to “gauge” the Lie groups—that is, to make the action of the group vary spatially. Gauging the Lie groups allows us to work with a much richer deformation space.

It should be appreciated that the embodiments described above are to be considered in all respects only illustrative and not restrictive. The scope of the invention is indicated by the following claims rather than by the foregoing description. All changes that come within the meaning and range of equivalents are to be embraced within their scope.

1. A method of improving the computation efficiency of a nonlinear optimization programming algorithm, comprising the steps of:
providing a first nonlinear surface, the first nonlinear surface including a first plurality of points;
determining a second nonlinear surface as a function of the first nonlinear surface, the second nonlinear surface including a second plurality of points, each of the second plurality of points corresponding to one of the first plurality of points and including an associated value;
receiving an objective function equation;
selecting one of the second plurality of points to be a reference point; and
maximizing the objective function equation by the substeps of: computing a gradient direction line from the reference point, in which the associated value of a point in proximity to the reference point is greater than both the associated value of the reference point and the associated values of any other point in proximity to the reference point, determining the point along the gradient direction line having the highest associated value, and adjusting the reference point to be the point resulting from the above determining step.

2. The method of claim 1 further comprising the step of repeating the maximizing step until no point exists in which the associated value is greater than the associated value of the reference point or of the associated values of any other point in proximity to the reference point.

3. The method of claim 2 wherein the first nonlinear surface is based on Lie manifold principles.

4. The method of claim 2 wherein the second nonlinear surface is based on Lie algebra principles.

5. The method of claim 2 wherein the second nonlinear surface is an exponential function of the first nonlinear surface.

6. The method of claim 2 wherein the objective function equation is based on the second plurality of points.

7. The method of claim 2 wherein the reference point is initially selected based on a random process.

8. A method of optimizing a real-valued function, comprising the steps of:
defining a lie group by a matrix representation of a lie manifold, wherein the lie manifold includes a continuum of curves;
obtaining lie algebra by computing a plurality of tangent vectors to the lie manifold;
selecting a locally optimal curve from the continuum of curves of the lie manifold;
determining a locally optimal direction of the lie algebra;
computing a point of the continuum of curves of the lie manifold; and
maintaining feasibility by moving along the locally optimal curve on the lie manifold as a function of the lie algebra.

9. The method of claim 8, further comprising a gradient of a pull back function to determine the locally optimal direction of the lie algebra.

10. The method of claim 8, further comprising exponentiating a gradient vector of the lie algebra to compute the point of the continuum of curves of the lie manifold.

11. The method of claim 8, further comprising exponentiating a gradient vector of a square matrix of the lie group to compute the point of the continuum of curves of the lie manifold.
